(19) United States
(12) Patent Application Publication
(10) Pub. No.: US 2014/0098536 A1
(43) Pub. Date: Apr. 10, 2014

(54) Electric Lighting Devices

(71) Applicant: Candella LLC, (US)

(72) Inventor: Jeff Thompson, Huntington Beach, CA (US)

(73) Assignee: Candella LLC, Orange, CA (US)

(21) Appl. No.: 13/886,944

(22) Filed: May 3, 2013

Related U.S. Application Data
(60) Provisional application No. 61/756,300, filed on Jan. 24, 2013.
(60) Provisional application No. 61/643,076, filed on May 4, 2012.

(51) Int. Cl. F21V 21/108; F21V 21/14

(52) U.S. Cl. CPC F21V 21/108; F21V 21/145
USPC 362/249.01; 362/392; 362/393

(57) ABSTRACT

Electric lighting devices having a counterweight are provided. One or more electric candles can be coupled to one or more counterweight elements configured to ensure that the electric candles maintain a substantially upright or vertical position when displayed.

This application claims the benefit of priority to U.S. Provisional Application No. 61/756,300, filed on Jan. 24, 2013, and U.S. Provisional Application No. 61/643,076, filed on May 4, 2012. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is electric lighting devices, especially electric candles.

### BACKGROUND

The following background discussion includes information that may be useful in understanding the present invention. It is not an admission that any of the information provided herein is prior art or relevant to the presently claimed invention, or that any publication specifically or implicitly referenced is prior art.

Various decorative lights have been used for quite some time to decorate for holidays and other occasions. For example, LED light strings are widely used during Christmas to decorate houses and Christmas trees. While efforts have been made to improve the efficiency and reliability of the decorative lights, such as by using LEDs, the overall appearance of the lights remains similar and artificial.

It is also known to place lights inside of a bulb or other container to provide additional decoration. See, e.g., U.S. Patent Publ. No. 2009/0103287 to Medley. However, little effort has apparently been made to produce decorative lights having a more realistic appearance to that of a real flame.

There have also been efforts placed in providing housings for candles or other lights, such that the lights can hang from trees or ceilings. One example can be found in U.S. Patent Publ. No.2011/0279034 to Lucas et al. However, these efforts appear to be directed towards lanterns having a top hanging loop mechanism, which apparently limits the areas in which the housings can be displayed.

Thus, there is still a need for lighting device having a realistic flame effect and improved display mechanisms.

### SUMMARY OF THE INVENTION

The inventive subject matter provides apparatus, systems and methods of an electric lighting device that is preferably configured to properly balance on a tree limb or other non-horizontal surface such that the electric lighting device can be maintained in a substantially vertical position while displayed.

As used herein, the term “substantially vertical position” means upright or within 15 degrees of being upright. For example, where a housing resembles a pillar candle, a substantially vertical position would be maintained where a flat bottom portion of the housing is parallel to a flat surface (e.g., a floor, etc.), or where a flat bottom portion creates a 15 degree angle or less with a flat surface.

In some contemplated embodiments, the electric lighting device of the inventive subject matter can comprise a gravity-assisted mechanism to maintain an upright position. To ensure that the lighting devices each remain in a substantially vertical position, it is contemplated that each of the lighting devices can include a counterweight or other component to thereby utilize gravity to maintain its upright position.

In one aspect of the inventive subject matter, an electric lighting device comprises an a candle shape housing, a movable flame element coupled to an upper portion of the housing and disposed such that the flame element at least partially extends from the upper portion, and a light source configured to emit light on to the flame element. A curved arm can couple the lighting device to a weight element, which is selected to help maintain a substantially vertical position of the electric lighting device. Where the device includes a movable flame element, it is critical that the device be displayed in a substantially vertical position to ensure that the flame element can properly move to produce a realistic flame effect. If the device is oriented in a non-substantially vertical position, the effect will typically be diminished or destroyed, which significantly reduces the attractiveness of the device.

In other contemplated embodiments, a string of lighting devices can be provided with each lighting device individually producing a realistic flame effect. Each of the lighting devices can be electrically coupled to one another. In some contemplated embodiment, the lighting devices can each include an aperture through which a wire or other object can pass through, allowing the lighting devices to freely rotate about the wire. In such embodiments, it is further contemplated that each of the devices can have a bottom portion having a greater weight than the devices' upper portions. This advantageously utilizes gravity by causing the lighting devices to rotate until the devices are each in a substantially vertical position. For example, by stringing the wire across branches of a tree, the string of lighting devices can each be maintained a substantially vertical position about the wire. In one embodiment, each lighting device can be coupled to or include a weight element to maintain a substantially vertical position, even where the string of lights is hung in a non-horizontal configuration.

It is further contemplated that the lighting devices could comprises a housing having a flame element extending therefrom, and a fastener coupled to the housing, such that the lighting devices can each be attached to a object or surface. In one preferred embodiment, the fastener can include a clip, which quickly allows the lighting devices to be clipped to a branch or other object or surface. However, a hook or any other commercially suitable fastener(s) could be used. In such embodiments, it is especially preferred that the device includes a ball joint or other component such that the housing can be oriented into a desired position, typically a substantially vertical position.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of one embodiment of an electric candle device of the inventive subject matter.

FIG. 2 is a schematic of one embodiment of an arm coupled with a weight element.

FIG. 3 is a schematic of another embodiment of an electric candle device of the inventive subject matter.

FIG. 4 is a schematic of yet another embodiment of an electric candle device.

FIG. 5 is a schematic of one embodiment of a string of lighting devices of the inventive subject matter.

FIG. 6 is a schematic of one embodiment of an electric candle device, wherein a flame element is disposed within a housing.

FIG. 7 is a schematic of another embodiment of an electric candle device.

FIG. 8A is a perspective view of another embodiment of an electric candle device.

FIG. 8B is a top view of the electric candle device of FIG. 8A.

FIG. 9A is a schematic of an electric candle coupled to a clip via a ball joint.

FIG. 9B is a schematic of another electric candle coupled to a clip via a ball joint.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

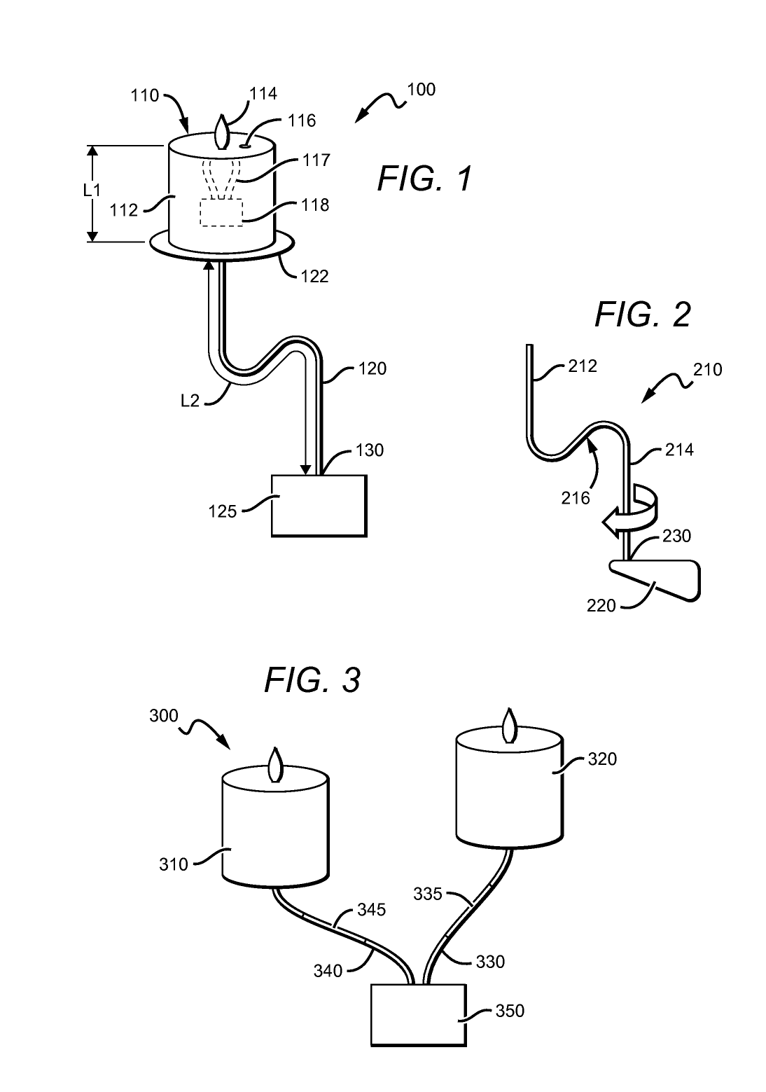

FIG. 1 is a schematic of one embodiment of an electric lighting device 100 of the inventive subject matter. Electric lighting device 100 comprises an electric candle 110 and an arm 120 coupled with a weight element 125. Optionally, device 100 can include a base 122 that in some contemplated embodiments can be configured to provide the appearance of a bobeche or drip protector often used with traditional wax candles.

It is contemplated that the candle 110 can be rotatably coupled to base 122 and/or arm 120 such that the candle 110 can rotate with respect to the base 122 and/or arm 120. In this manner, a face or front surface of a flame element of the candle 110 can be oriented after the device 100 is mounted or otherwise resting on a mounting surface or object, which increases the number of locations where the device 100 can be installed while still allowing the candle's flickering flame effect to be viewed.

Electric candle 110 has various components, including a housing 112 in which wires 117 and power source 118 can advantageously be disposed. Alternatively or additionally, it is contemplated that candle 110 can utilize an external power source such as a line voltage. Other contemplated power sources can include, for example, one or more batteries, a photovoltaic cell, or any other commercially suitable power source(s).

Electric candle 110 also comprises a flame element 114 that extends from an upper portion of the housing 112, and a light source 116 configured to emit a spot of light on to the flame element 114. It is contemplated that the light source 116 can be positioned or configured to emit a light on flame element 114 from a top position, side position, bottom position, or any other suitable position.

It is especially preferred that the flame element be coupled to the housing 112 such that the flame element is movable with respect to the housing. In such embodiments, the candle 110 can further include a drive mechanism, which can facilitate movement of the flame element to generate a flickering flame effect due to the interaction of the light source(s) with the flame element as it moves. Contemplated drive mechanisms include, for example, an electromagnet, a wheel, a fan or other means for moving air or causing pressure differentials within the housing 112, and so forth. Exemplary configurations of moving the flame element are described in U.S. Pat. Nos. 7,159,994, 7,261,455, 7,837,355, 8,070,319, and 8,132,936, and U.S. Patent Publication Number 2011/0127914.

In some contemplated embodiments, for example, flame element 114 can be pivotally coupled to the housing 112, which allows the flame element 114 to move with respect to the housing 112. It is further contemplated that the flame element 114 can have an aperture through which a support wire may extend. Preferably, a diameter of the aperture is at least slightly larger than a diameter of the support wire to provide for additional chaotic or random movement of the flame element 114 with respect to housing 112 and the support wire. Support wire may be a straight wire, a V-shaped wire, or other shape. Alternatively, support tabs could be inserted on either side of the flame element to thereby support flame element.

An electromagnet (e.g., a coil) or fan could be disposed below the flame element 114. Where an electromagnet is used, it is contemplated that the flame element could have a magnet, for example, which can interact with the electromagnetic field create by the electromagnet to thereby cause movement of the flame element 114. Where a fan is used, it is contemplated that air from the fan could cause movement of the flame element 114 with respect to housing 112.

As shown, electric candle 110 is attached to, or otherwise coupled to, base 122. However, it is contemplated that candle 110 could be directly attached to arm 120 or a weight element. In embodiments where an arm is included, it is preferred that a length L2 of arm 120 is larger than a height L1 of candle 110. However, all suitable ratios of arm length to candle height are contemplated, including for example, 0.5:1, 1:1, 1.5:1, 2:1, 3:1, or any other suitable ratio.

Weight element 125 and electric candle 110 can have any suitable weight to weight ratio (e.g., 0.5:1, 1:1, 1.5:1, 2:1, 3:1, etc.), which can be dependent or independent of a shape of arm 120. For example, weight element 125 and electric candle 110 can have substantially the same weight where a curvature of arm 120 is located substantially mid-length. Alternatively or additionally, weight element 125 and a combination of electric candle 110 and base 122 can have any suitable weight to weight ratio (e.g., 0.5:1, 1:1, 1.5:1, 2:1, 3:1, etc.). For example, weight element 125 can weigh 0.6 pounds, and a combination of electric candle 110 and base 122 can weigh 0.3 pounds, resulting in a 2:1 ratio. The specific ratio of weights is dependent on the location of the center of mass of device 100. However, as discussed above, device 100 is preferably configured such that the center of mass is below candle 110, and device 100 is bottom heavy to utilize gravity to maintain a substantially vertical position of candle 110.

FIG. 2 is a schematic of one contemplated embodiment of an arm 210 coupled with a weight element 220. In this embodiment, arm 210 comprises a first component 212 that can be rotatably coupled with a second component 214. Arm 210 further comprises a preferably S-shaped mid-portion 216, which can advantageously be sized and dimensioned to allow arm to rest on a branch or other object or surface. Although it is contemplated that the arm could comprise any commercially-suitable shape, preferred arms have at least one concave portion, such that arm 210 can rest on a branch or other object. In some embodiments, arm 210 can comprise any suitable curvature or angles (e.g., C-shaped, V-shaped, W-shaped, etc.), which may be a portion of device 100 coming into contact with a display shelf, tree branch, bookshelf, or any other suitable item, for example.

It is contemplated that arm 210 can comprise a first component 212 and a second component 214 along any portion of arm 210, which may or may not be separable components from one another. The division between first and second components 212 and 214 may be near a weight element, at a S-shaped or other shaped mid-portion, near the electric candle or base attachment point, or any other portion thereof. Moreover, it is contemplated that arm 210 can comprise a third component, a fourth component, or any other suitable number of components coupled to one another. Such components, where rotatable or otherwise movable with respect to one another, can advantageously allow a user to vary the shape of the arm to properly balance the electric candle and maintain its orientation in a substantially vertical position.

As shown in FIG. 1, it is contemplated that arm 120 can be coupled to a weight element 125 that preferably has a uniform weight distribution across a width of the weight element 125, and the attachment point 130 can be a central portion of the weight. As shown in FIG. 2, it is alternatively contemplated that weight element 220 can have a non-uniform weight distribution across its length or width, and that attachment point 230 can be at a non-central point of the weight element. The embodiment shown in FIG. 2 can advantageously allow a user to cause an electric candle to tilt in various directions by rotating the weight element 220, for example. It is contemplated that this rotation of weight element 220 can be achieved by rotating second component 214 in relation to first component 212, or by rotating weight element 220 with respect to arm 210.

Contemplated weight elements can comprise any suitable shape, size or material. For example, the weight element could comprise a single block of metal, wood, plastic, cork, or any other commercially suitable material, and may have an ornamental design.

FIG. 3 is a schematic of another embodiment of an electric lighting device 300 of the inventive subject matter. Device 300 comprises a first electric candle 310 coupled to second arm 340 and weight element 350, and a second electric candle 320 coupled to first arm 330 and weight element 350.

It is contemplated that one or both arms 330 and 340 can have a movable (e.g., bendable, twistable, pivotable, etc.) portion 335 and 345. Alternatively, device 300 could include a ball or other joint at a point where the candle 310 meets the arm 340, for example. This movable portion can advantageously allow a user to attach the device 300 to an object or surface. A movable arm can comprise any commercially suitable material(s), including for example, a flexible metal tubing, flexible wires, plastic, and so forth. It is further contemplated that the arm could be extendable, such that a length of the arm can be varied.

In this embodiment, the total weight of weight element 350 can comprise any amount such that the weight ratio of the weight element to that of first electric candle 310, second electric candle 320, or both first and second electric candles is sufficient to maintain a substantially vertical position of the first and second candles 310 and 320. For example, weight element 350 could have substantially the same weight as a combined weight of the first and second electric candles 310 and 320.

Moreover, it is contemplated that a single weight element 350 can be coupled to three, five, or even ten or more electric candles.

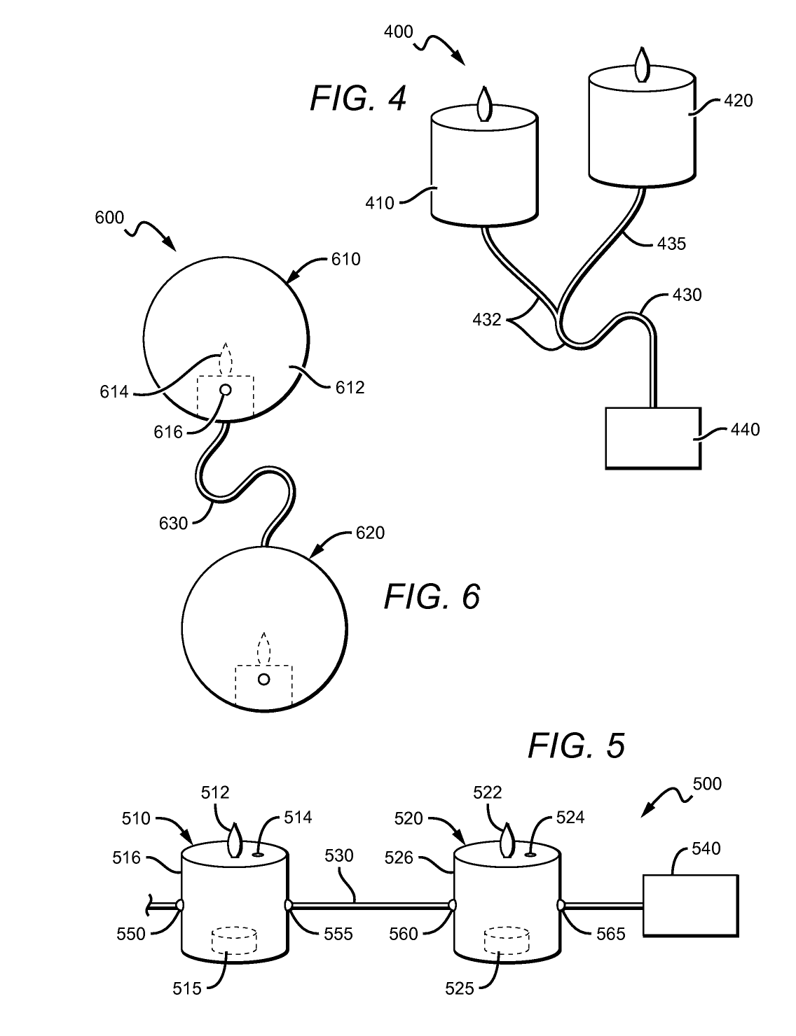

FIG. 4 is a schematic of yet another embodiment of an electric lighting device 400 comprising a first electric candle 410, a second electric candle 420, a first arm 430 having first component 432 and second component 435, and a weight element 440.

First arm 430 comprises an S-shaped portion that can be used to hang on a branch of a tree, among other things. Weight element 440 can be used to keep first and second electric candles 410 and 420 at a substantially vertical position, with or without the assistance of optionally bendable portions of first component 432 and second component 435. For example, it is contemplated that first component 432 could comprise a bendable portion that can be curved, for example, into a second S-shaped portion. It is also contemplated that second component 435 could comprise a bendable portion that can be curved, for example, into a third S-shaped portion. In this manner, electric lighting device 400 can comprise three portions that can couple with three different portions of a tree or other item, to provide increased stability.

FIG. 5 is a schematic of one embodiment of a string of lighting devices 500 of the inventive subject matter, which comprises a first electric candle 510 having a first flame element 512, a first light source 514, and a first weight element 515. The first electric candle 510 is electrically coupled to second electric candle 520 via at least one wire 530, which is coupled to a power source 540. The second electric candle 520 comprises a second flame element 522, a second light source 524, and a second weight element 525.

In some embodiments, wire 530 electrically couples a plurality of electric candles including the first and second candles 510 and 520, which can be electrically coupled in parallel or in series. Wire 530 may also pass through the housings of the plurality of electric candles through aperture(s) (e.g., 550, 555, 560, 565, etc.). However, it is alternatively contemplated that the wire passing through the housings could be distinct from the electric wire providing power to the plurality of candles.

It is further contemplated that the housings 516 and 526 can be substantially hollow, or can be substantially filled with material(s) (e.g., polystyrene foam, cotton, plastic, metal, etc.) except for a hollow through-hole through which wire 530 can pass through.

Each of the electric candles may advantageously include a weighted bottom. The weighted bottom can comprise some or all of the electronics or other component of the electric candles, or be a separate weight element. For example, weight elements 515 and 525 could be disposed within the first and second candles 510 and 520, and sized such that a bottom of the light source is downwardly pulled causing the electric candles to pivot about the wire 530 as necessary such that the candles 510 and 520 are in a substantially vertical position. Weight elements 515 and 525 are preferably attached to a bottom portion of electric candles 510 and 520.

In some preferred embodiments, a total weight of weight element of an electric candle can comprise at least 50%, at least 70%, at least 80% or even 90% or more of the weight of the electric candle.

FIG. 6 is a schematic of one embodiment of an electric lighting device, wherein a flame element is disposed within an outer housing. Device 600 comprises a first electric candle 610 having an outer housing 612, first flame element 614 and first light source 616. Here, the flame element 614 and light source 616 are disposed within outer housing 612, which can be a closed or open container made of any suitable material (e.g., paper, glass, plastic, metal, wood, etc.).

It is contemplated that light source 616 can be disposed below the flame element 614, and emit light from beneath the flame element. In other embodiments, the flame element 614 could be lit from above, from a side, or from any other suitable direction.

First electric candle 610 is coupled to a weight element 620 via an arm 630. This weight element 620 is configured to keep first electric candle 610 in a substantially vertical position. In this embodiment, weight element 620 comprises a second electric candle having similar components to first electric candle 610. It is contemplated that in other elements, weight element 620 can solely function to keep an electric candle in a substantially vertical position, or be decorative in nature.

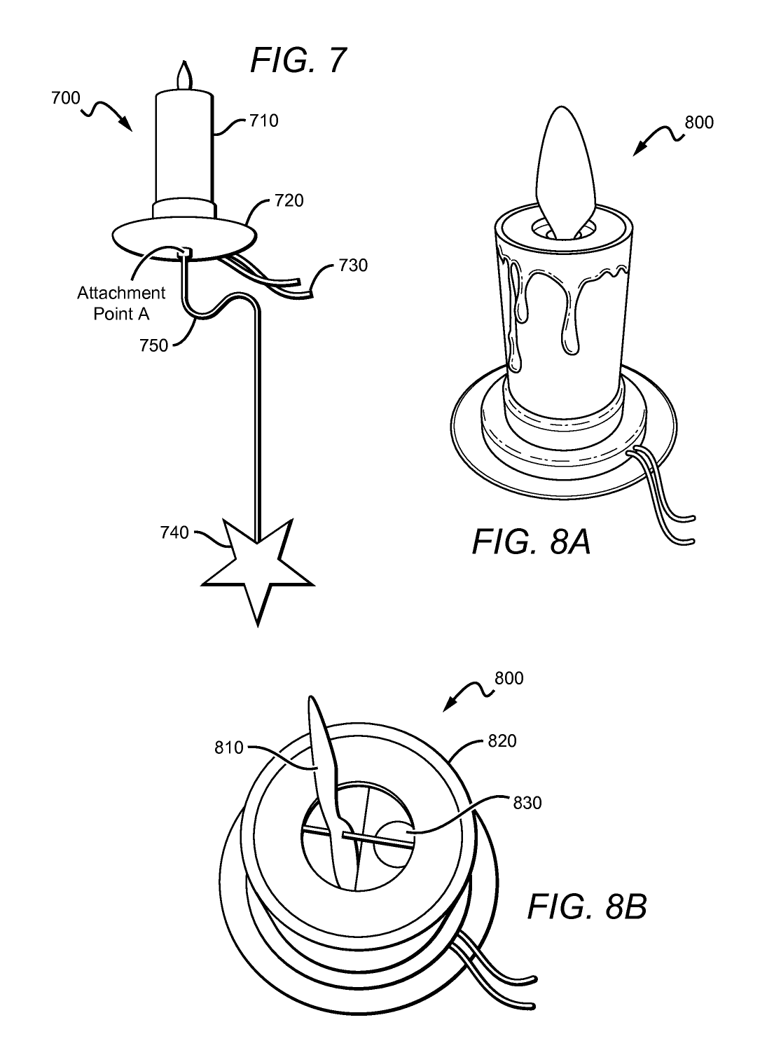

FIG. 7 is a schematic of another embodiment of an electric lighting device 700 comprising an electric candle 710 coupled to base 720. Wires 730 are coupled to a light source of electric candle 710 via base 720, and can connect to an external power source. Alternatively or additionally, electric lighting device 700 can be powered by a battery, photovoltaic cell, or any other commercially suitable power source.

It is contemplated that base 720 could be rotatably coupled to arm 750 at attachment point A, such that a face of the flame element can be oriented to face in a desired direction as needed. This advantageously allows the device 700 to be mounted in more locations as the candle 710 can be rotated once the device 700 is attached to or resting on an object or surface. Arm 750 comprises an S-shaped mid-portion, and is coupled to a decorative weight 740. Weight 740 is configured to keep electric candle 710 in a substantially vertical position when coupled to an item via an S-shaped portion of arm 750.

FIGS. 8A-8B are perspective and top views of an embodiment of an electric lighting device 800, which shows a flame element 810 coupled to a top portion of housing 820, and a light source 830 configured to emit light on flame element 810 from a low side position.

Rather than having a counterweight or weight element, the electric candles can include a clip or other fastener to secure, mount, or rest the lighting device to a tree limb or other surface. In such embodiments, it is contemplated that the lighting device could be coupled to the clip or other fastener via a ball joint. This advantageously allows the lighting device to be angled with respect to the clip or other fastener such that the lighting device has a generally upright orientation.

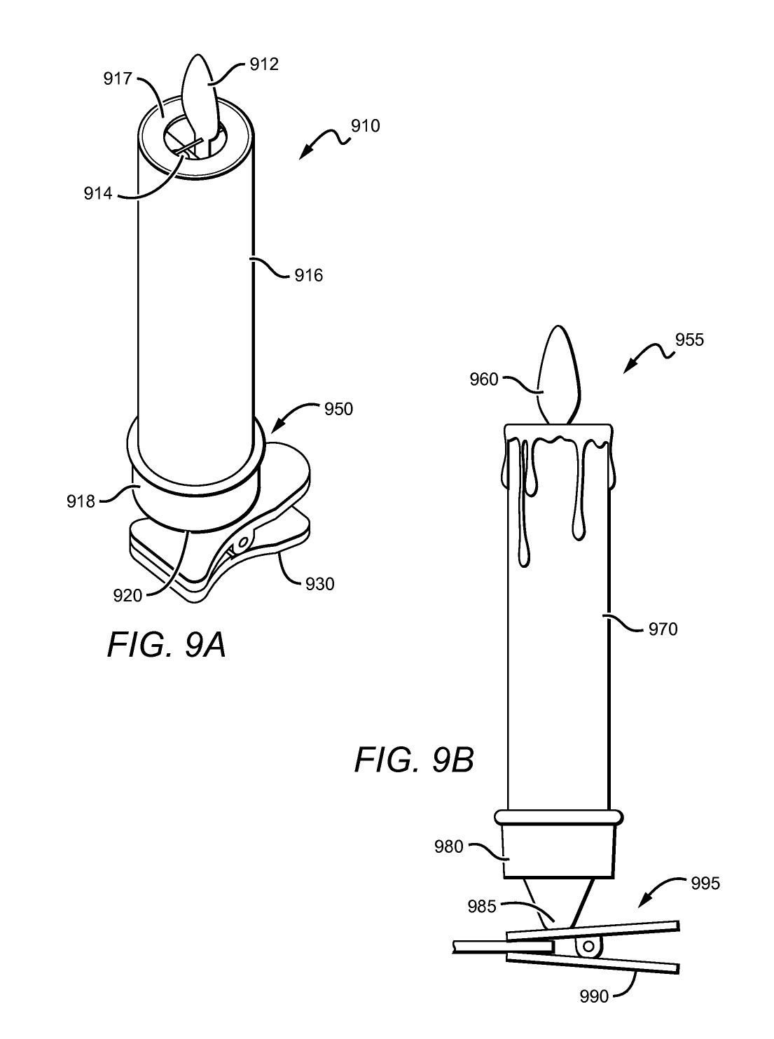

FIG. 9A shows a schematic of an electric candle coupled to a clip via a ball joint. Electric candle 910 comprises a housing 916, a flame element 912 extending from a top portion of housing 917, and a light source 914 located underneath a top portion of housing 917.

Fastener 950 comprises a base 918, which may be sized and dimensioned to receive a bottom portion of housing 916, a ball joint 920, and a clip 930. Clip 930 advantageously allows a user to quickly attach and display electric candle 910 in numerous locations, including for example, on a tree branch, on a shelf, on a tabletop, or any other suitable location. At the same time, ball joint 920 advantageously allows a user to adjust an angle of electric candle 910 with respect to clip 930, such that the candle 910 can be oriented in a substantially vertical position. This is critical to create the flickering flame effect caused by a reflection of light on the flame element 912 as it moves with respect to housing 916. For example, electric candle 910 can be kept at a position perpendicular to clip 930 where the clip 930 is placed on a flat surface (e.g., an end of a shelf, etc.). On the other hand, electric candle 910 can be kept at a 110 degree angle with respect to the clip 930 where the clip is placed on a tree branch at an angle.

Device 900 could further include an extension component allowing a vertical position of the candle 910 with respect to base 918 to be varied. Alternatively, candle 910 itself could be configured to allow for a varying height.

FIG. 9B shows a schematic of an electric candle similar to that of FIG. 9A. Electric candle 955 comprises a flame element 960, housing 970, and is sized and dimensioned to couple with holder 995. Holder 995 comprises a base 980, which can receive a bottom portion of housing 970, a ball joint 985 configured to allow an angular adjustment of electric candle 955 with respect to clip 990.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used herein, and unless the context dictates otherwise, the term “coupled to” is intended to include both direct coupling (in which two elements that are coupled to each other contact each other) and indirect coupling (in which at least one additional element is located between the two elements).

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An electric lighting device, comprising:
a first electric candle having a first housing, a first flame element coupled to an upper portion of the housing, and a first light source configured to emit light on the first flame element; and
a first curved arm coupled to a first weight element, wherein the first curved arm is coupled to the first electric candle, and wherein the first weight element is configured to cause the first electric candle to remain in a substantially vertical position.

2. The device of claim 1, wherein a length of the first arm is larger than a length of the first electric candle.

3. The device of claim 2, wherein the arm comprises a substantially S-shaped mid-portion.

4. The device of claim 1, wherein at least a portion of the arm is movable.

5. The device of claim 4, wherein the at least the portion of the arm is bendable.

6. The device of claim 1, wherein the arm comprises a first component rotatably coupled to a second component.

7. The device of claim 6, wherein the arm couples to a non-central portion of the weight element.

8. The device of claim 1, wherein a weight of the weight element is substantially the same as a weight of the first electric candle.

9. The device of claim 1, further comprising a second electric candle coupled to the weight element.

10. The device of claim 9, wherein a weight of the weight element is substantially the same as a combined weight of the first and second electric candles.

11. An electric lighting device, comprising:
a first electric candle having a first housing, a first flame element disposed in the housing, and a first light source configured to emit light on the first flame element; and
a first curved arm coupled to a first weight element, wherein the first curved arm is coupled to the first electric candle, and wherein the first weight element is configured to cause the first candle portion to remain in a substantially vertical position.

12. The device of claim 11, wherein the first weight element comprises a second electric candle.

13. The device of claim 11, wherein the first weight element comprises a single piece of material.

14. The device of claim 11, wherein the first weight element comprises an ornamental design.

15. The device of claim 11, wherein the first curved arm comprises a substantially S-shaped mid-portion.

16. The device of claim 11, wherein the first light source is configured to emit light on the first flame element from an area underneath the first flame element.
